(19) United States
(12) Patent Application Publication
(10) Pub. No.: US 2011/0041853 A1
(43) Pub. Date: Feb. 24, 2011

(54) CIRCUIT FOR SUPPLYING A RESPIRATORY GAS TO AN AIRCRAFT PASSENGER FROM A PRESSURIZED SOURCE COMPRISING A PRESSURE REGULATING UNIT

(75) Inventors: WOLFGANG RITTNER, Siblin (DE); Rudiger Meckes, Berkenthin (DE)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: INTERTECHNIQUE, S.A., Plaisir Cedex (FR)

(21) Appl. No.: 12/846,026

(22) Filed: Jul. 29, 2010

Related U.S. Application Data
(60) Provisional application No. 61/235,717, filed on Aug. 21, 2009.

(51) Int. Cl. A62B 9/02

(52) U.S. Cl. 128/205.24

(57) ABSTRACT

The present invention relates to a circuit for supplying a respiratory gas to an aircraft passenger comprising a pressurized source of the respiratory gas, a respiratory mask for the aircraft passenger, and a supply line coupled between the pressurized source and the respiratory mask for supplying the respiratory gas from the pressurized source to the respiratory mask. In order to reduce the weight of the circuit, the pressurized source comprises a pressure regulating unit coupling the pressurized source to the supply line, wherein the pressure regulating unit comprises a valve body being movable from a sealing position to a regulating position range and a motor unit for regulating the pressure of the respiratory gas supplied to the supply line by moving the valve body within the regulating position range, wherein, when the valve body is in the sealing position, the pressurized source is sealed, and, when the valve body is in the regulating position range, the pressurized source is adapted for supplying the respiratory gas to the supply line.

### CROSS-REFERENCE TO RELATED APPLICATION

This application claims the benefit of U.S. Provisional Application No. 61/235,717 filed on Aug. 21, 2009, the contents of which are incorporated herein by reference.

### BACKGROUND OF THE INVENTION

The present invention relates to a circuit for supplying a respiratory gas to an aircraft passenger comprising a pressurized source of the respiratory gas, a respiratory mask of the aircraft passenger, and a supply line coupled between the pressurized source and the respiratory mask for supplying the respiratory gas from the pressurized source to the respiratory mask. The invention also relates to a pressurized source of a respiratory gas for being used in circuit for supplying the respiratory gas to an aircraft passenger.

According to aviation regulations it is required that oxygen may be supplied to the aircraft passenger on board for aircrafts in case of a depressurization accident or the occurrence of smoke in the aircraft. These aviation regulations are usually fulfilled by providing a circuit for supplying a respiratory gas to the aircraft passengers which comprises a pressurized source of the respiratory gas, a respiratory mask for each of the aircraft passengers and crew members, and a supply line coupled between the pressurized source and the respiratory mask for supplying the respiratory gas from the pressurized source to the respiratory mask.

US 2007/0144597 A1 discloses a circuit for supplying oxygen to aircraft passengers. The high pressure cylinder containing oxygen is coupled to a line by means of a pressure reducer which delivers oxygen at a gage pressure to the line. The line is coupled to a pressure regulator for the respiratory masks of the crew and to a regulation unit for regulating the pressure of the oxygen provided to the passenger masks. The regulation unit comprises a pressure regulator for regulating the pressure of the oxygen supplied to the passenger masks. The regulation unit is controlled by an electronic control unit for avoiding systematic oxygen overconsumption and hence for allowing a reduction of the size or number of oxygen cylinders and their weight to be stored in the aircraft.

However, the system according to US 2007/0144597 A1 is prone to a leakage of oxygen through the number of entities coupled between the oxygen cylinder and the respiratory masks. Also, the system loses respiratory gas through a bypass line bypassing the pressure regulator for the passenger masks even in case the pressure regulator is controlled to be locked. Thus, it is necessary to load the aircraft with a plurality of oxygen cylinders for compensating the loss of oxygen during operation as well as in standby.

### SUMMARY OF THE INVENTION

It is an object of the present invention to provide a circuit for supplying a respiratory gas to an aircraft passenger of less weight.

According to the invention the problem is solved by a circuit for supplying a respiratory gas to an aircraft passenger which comprises: a pressurized source of the respiratory gas, a respiratory mask for the aircraft passenger, and a supply line coupled between the pressurized source and the respiratory mask for supplying the respiratory gas from the pressurized source to the respiratory mask, wherein the pressurized source comprises a pressure regulating unit coupling the pressurized source to the supply line, wherein the pressure regulating unit comprises a valve body being movable from a sealing position to a regulating position range and a motor unit for regulating the pressure of the respiratory gas supplied to the supply line by moving the valve body within the regulating position range, wherein, when the valve body is in the sealing position, the pressurized source is sealed, and, when the valve body is in the regulating position range, the pressurized source is adapted for supplying the respiratory gas to the supply line.

The invention is based on the idea of providing the pressurized source with a pressure regulating unit with an integrated sealing mechanism. Therefore, there is no loss of the respiratory gas during the standby operation as the pressurized source is sealed. The sealing of the pressurized source is achieved by arranging the valve body in the sealing position. In case of an emergency the sealing of the pressurized source is disabled by moving the valve body to a regulating position range which, at the same time, determines the pressure of the respiratory gas applied to the supply line. By controlling the position of the valve body within the regulating position range the pressure applied to the supply line and thus to the respiratory masks is regulated. Therefore, the valve body according the present invention serves as a sealing mechanism as well as a pressure regulating mechanism. Therefore, several distinct pressure regulator units can be saved thus also avoiding the risk of leaks which are associated to every unit coupled to a gas supply system. Also, the weight of the overall circuit is reduced. Further, as the amount of respiratory gas leakage is reduced the size or number of pressurized sources, for example, oxygen cylinders, and hence their weight can be reduced.

Preferably, the pressure regulating unit further comprises a spring element holding the valve body in the sealing position. Thus, the spring element advantageously ensures that the valve body is in the sealing position all the time except for emergency cases. This arrangement further provides the advantage that the pressurized source is sealed during transport between a filling station and the mounting of the pressurized source within the circuit of the aircraft.

Preferably, the spring element is further adapted to move the valve body from the regulating position range to the sealing position. Thus, the spring element is adapted to serve as a multiply closing mechanism which causes the valve body to move into the sealing position also in case the pressurized source was already activated and opened. Thus, a pressurized source can be used multiple times and it is not necessary to exchange the pressurized source after the sealing was once opened.

Preferably, the motor unit is adapted to move the valve body in a direction opposite to the direction of force, which is applied to the valve body by the spring element. Accordingly, two forces are applied to the valve body in opposite directions: a first force applied by the spring element directs the valve body to the sealing position and a second force applied by the motor unit directs the valve body to the regulating position range. Depending on the situation the ratio of the first and second force is changed: during standby, the first force equals or is greater than the second force thus allowing the valve body to seal the pressurized source; in an emergency situation the second force is greater than the first force thus moving the valve body to the regulating position range and opening the pressurized source for supplying the respiratory gas to the respiratory mask. Thus, also in case of a breakdown of the motor unit it is ensured that the pressurized source is sealed and no leakage occurs.

Preferably, the motor unit comprises a piezo actuator. The usage of a piezo actuator provides the advantage of moving the valve body with a high accuracy.

Preferably, the pressure regulating unit comprises a pressure regulating chamber and a high pressure chamber, wherein the pressure regulating chamber and the high pressure chamber are connected by an opening, which is sealed when the valve body is in the sealing position and which is open when the valve body is in the regulating position range. Thus, the inventive circuit provides a highly integrated pressure regulating unit which fulfils a function of a closing mechanism and of a pressure regulating mechanism by varying the position of the valve body between the two chambers. Thus, further entities like separate regulating means can be omitted and the weight of the overall circuit is reduced.

Preferably, the spring element is comprised in the high pressure chamber and causes the valve body to seal the opening. This arrangement provides the advantage that the high pressure chamber is self-sustaining for the sealing operation of the pressurized source. Therefore, also in case of malfunction of the pressure regulating chamber a leakage from the pressurized source is avoided.

Preferably, the high pressure chamber comprises a fill pressure gauge for determining the pressure of the respiratory gas within the pressurized source. By integrating the fill pressure gauge to the high pressure chamber further distinct entities can be omitted and the weight of the overall circuit can be reduced. Further, such arrangement allows the user of the pressurized source to quickly identify the status of the pressurized source and to determine if it should be exchanged. Thus, the storing of backup pressurized sources is not necessary thereby further reducing the weight to be carried in an aircraft using the inventive circuit.

Preferably, the pressure regulating chamber comprises a temperature sensor for determining the temperature within the pressure regulating chamber. Also, it is preferred that the pressure regulating chamber comprises a regulator pressure sensor for determining the pressure within the pressure regulating chamber. By providing a highly integrated pressure regulating unit with integrated sensors the weight of the pressurized source and thus the circuit can be further decreased.

Preferably, the circuit further comprises an altitude pressure sensor for determining the pressure within the cabin. Such a sensor provides the advantage of determining a situation of depressurization within the cabin indicating a situation in which the valve body is to be moved from the sealing position to the regulating position range and, optionally, of activating the provision of the respiratory masks to the aircraft passengers and crew.

Preferably, the circuit further comprises a control unit coupled to the regulator pressure sensor, to the temperature sensor and to the altitude pressure sensor, wherein the control unit is adapted for controlling the motor unit on basis of the determined pressures and temperature determined by the regulator pressure sensor, the temperature sensor and the altitude pressure sensor. Thus, the controlling mechanism for the motor unit consists of few units and provides at the same time an accurate controlling mechanism. The weight of the circuit is thus further reduced.

Preferably, the control unit comprises a memory for storing a correlation between a predefined pressure within the pressure regulating chamber and a predefined temperature within the pressure regulating chamber and/or a predefined pressure within the cabin. By predefining preferred correlations between the determined pressures and temperature, and optionally further data, stored, for example, in a table the operation of the circuit can be adapted to a plurality of different situations.

Preferably, the control unit is adapted for causing the motor unit to move the valve body within the regulating position range until the determined pressure within the pressure regulating chamber matches a predefined pressure within the pressure regulating chamber. By using determined pressure and temperature values and comparing them to predefined values stored in the memory the pressure regulation achieves a high grade of accuracy.

In another aspect the invention refers to a pressurized source of a respiratory gas for being used in a circuit for supplying the respiratory gas to an aircraft passenger, comprising: a pressure regulating unit for coupling the pressurized source to a supply line for supplying the respiratory gas from the pressurized source to a respiratory mask of an aircraft passenger, wherein the pressure regulating unit comprises a valve body being movable from a sealing position to a regulating position range and a motor unit for regulating the pressure of the respiratory gas supplied to the supply line by moving the valve body within the regulating position range, wherein, when the valve body is in the sealing position, the pressurized source is sealed, and, when the valve body is in the regulating position range, the pressurized source is adapted for supplying the respiratory gas to the supply line.

### BRIEF DESCRIPTION OF THE DRAWINGS

The invention will be described in the following be means of an exemplary embodiment on basis of the attached figures, wherein

FIG. 1 illustrates a circuit according to the exemplary embodiment of the invention with the valve body in the sealing position, and

FIG. 2 illustrates the circuit according to the exemplary embodiment of the invention with the valve body in the regulating position range.

### DETAILED DESCRIPTION

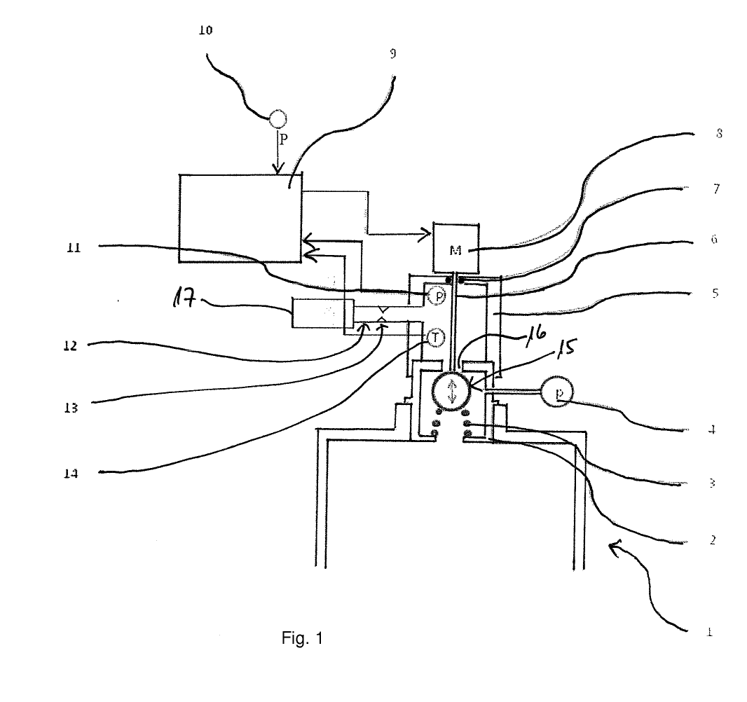

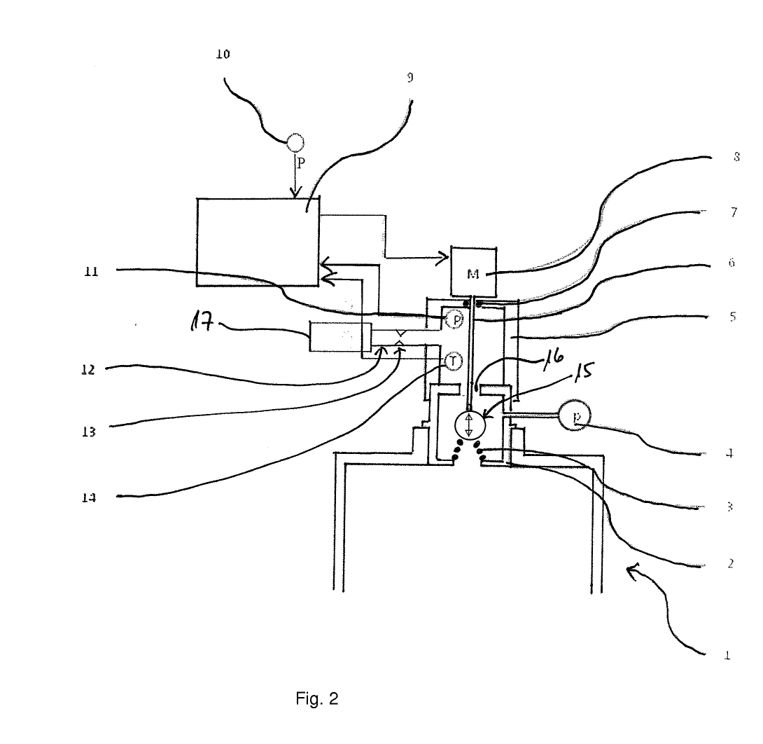

FIGS. 1 and 2 illustrate a pressurized source 1 which comprises a respiratory gas within an oxygen cylinder. The pressurized source comprises a pressure regulating unit comprising a high pressure chamber 2 and a pressure regulator chamber 5. The pressure regulator chamber 5 may be detached from the high pressure chamber 2 for, for example, filling or refilling the oxygen cylinder with oxygen, wherein, after the filling, the valve body 15 is pushed to the sealing position by spring element 3 thus operating as a check valve. It is to be noted that an oxygen cylinder with a high pressure chamber 2 for being coupled with a pressure regulated chamber 5 is adapted for being used with an inventive circuit. Also a supply line as well as an oxygen cylinder for being coupled to the inventive pressure regulating unit refer to essential elements of the invention.

Within the high pressure chamber there is a support spring as spring element 3 which pushes a valve body 15, for example a cone or a ball, to the valve seat in the opening 16. A fill pressure gauge 4 is coupled to the high pressure chamber 2 for determining the pressure within the high pressure chamber 2 and thus the oxygen cylinder and for providing the determined pressure value to the user.

The pressure regulator chamber 5 comprises an opening for guiding a linear drive 6 of a micro linear actuator 8, which is arranged outside the pressure regulator chamber 5. The opening for the linear drive 6 comprises a low pressure seal 7 for avoiding leakage. The linear drive 6 is also guided through opening 16 and coupled to valve body 15. The micro linear actuator 8 may be a linear piezo actuator of an electric motor with a mechanical linear drive 6.

In the sealing operation the valve body 15 is in the sealing position as indicated in FIG. 1. That is, the valve body 15 is pushed to the valve seat by the spring element 3 thereby hermetically closing the opening 16 between the high pressure chamber 2 and the pressure regulator chamber 5.

In case of a depressurization, smoke in the cabin et cetera the motor unit comprising the electrical motor 8 and the linear drive 6 is activated. The electrical motor 8 drives the linear drive 6 in the direction opposite to the direction of force, which is applied by the spring element 3 to the valve body 15. That is, the valve body 15 is pushed against the force of the spring element 3 thereby opening the gas flow of the respiratory gas from the oxygen cylinder to and increasing the pressure within the pressure regulator chamber 5 as illustrated in FIG. 2.

The method of operating the circuit of the exemplary embodiment is described in the following. The activation of the circuit and the amount of movement of the valve body 15 is controlled by the electronic control unit 9. In case of a depressurization the power supply for electronic control unit 9 is activated. The control unit 9 causes the electric motor 8 to move the linear drive 6 in direction of the valve body 15. As soon as valve body 15 is moved away from the opening 16, i.e. its position is within the regulating position range, oxygen flows into the pressure regulator chamber 5 of low pressure.

A temperature sensor 14 comprised in the pressure regulator chamber 5 determines the temperature within the pressure regulator chamber 5 and outputs the determined temperature value to the electronic control unit 9. The circuit further comprises an altitude pressure sensor 10 for determining the pressure in the cabin. Also the altitude pressure sensor 10 outputs the determined pressure of the cabin to the electronic control unit 9.

The electronic control unit 9 controls the movement of the valve body 15 depending on the determined pressure of the cabin and/or on the determined temperature in the pressure regulating chamber 5. The controlling is carried out until the required or predefined value of pressure within the low pressure regulator chamber 5 associated with the determined temperature is reached, wherein the pressure within the pressure regulator chamber 5 is determined by regulator pressure sensor 11, in order to allow a flow of oxygen depending on the cabin pressure through calibrated orifice 13 to a plurality of respiratory masks 17 through supply line 12.

The electronic control unit 9 further comprises a memory for storing a table which lists predefined pressure values for the pressure within the pressure regulator chamber 5 depending on the temperature within the pressure regulator chamber 5 and the pressure value of the cabin. Thus, the table provides information about the required flow of oxygen for the respiratory masks of the passengers and the crew members.

1. A circuit for supplying a respiratory gas to an aircraft passenger, comprising:
a pressurized source of the respiratory gas,
a respiratory mask for the aircraft passenger, and
a supply line coupled between the pressurized source and the respiratory mask for supplying the respiratory gas from the pressurized source to the respiratory mask,
wherein the pressurized source comprises a pressure regulating unit coupling the pressurized source to the supply line,
wherein the pressure regulating unit comprises a valve body being movable from a sealing position to a regulating position range and a motor unit for regulating the pressure of the respiratory gas supplied to the supply line by moving the valve body within the regulating position range, wherein,
when the valve body is in the sealing position, the pressurized source is sealed, and,
when the valve body is in the regulating position range, the pressurized source is adapted for supplying the respiratory gas to the supply line.

2. The circuit of claim 1, wherein the pressure regulating unit further comprises a spring element holding the valve body in the sealing position.

3. The circuit of claim 2, wherein the spring element is further adapted to move the valve body from the regulating position range to the sealing position.

4. The circuit of claim 2, wherein the motor unit is adapted to move the valve body in a direction opposite to the direction of force, which is applied to the valve body by the spring element.

5. The circuit of claim 1, wherein the motor unit comprises a piezo actuator.

6. The circuit of claim 1, wherein the pressure regulating unit comprises a pressure regulating chamber and a high pressure chamber, wherein the pressure regulating chamber and the high pressure chamber are connected by an opening, which is sealed when the valve body is in the sealing position and which is open when the valve body is in the regulating position range.

7. The circuit of claim 1, wherein the spring element is comprised in the high pressure chamber and causes the valve body to seal the opening.

8. The circuit of claim 1, wherein the high pressure chamber comprises a fill pressure gauge for determining the pressure of the respiratory gas within the pressurized source.

9. The circuit of claim 1, wherein the pressure regulating chamber comprises a temperature sensor for determining the temperature within the pressure regulating chamber.

10. The circuit of claim 1, wherein the pressure regulating chamber comprises a regulator pressure sensor for determining the pressure within the pressure regulating chamber.

11. The circuit of claim 1, wherein the circuit further comprises an altitude pressure sensor for determining the pressure within the cabin.

12. The circuit of claim 1, wherein the circuit further comprises a control unit coupled to the regulator pressure sensor, to the temperature sensor and to the altitude pressure sensor, wherein the control unit is adapted for controlling the motor unit on basis of the determined pressures and temperature determined by the regulator pressure sensor, the temperature sensor and the altitude pressure sensor.

13. The circuit of claim 12, wherein the control unit comprises a memory for storing a correlation between a predefined pressure within the pressure regulating chamber and a predefined temperature within the pressure regulating chamber and/or a predefined pressure within the cabin.

14. The circuit of claim 12, wherein the control unit is adapted for causing the motor unit to move the valve body within the regulating position range until the determined pressure within the pressure regulating chamber matches a predefined pressure within the pressure regulating chamber.

15. A pressurized source of a respiratory gas for being used in a circuit for supplying the respiratory gas to an aircraft passenger, comprising:
a pressure regulating unit for coupling the pressurized source to a supply line for supplying the respiratory gas from the pressurized source to a respiratory mask of an aircraft passenger,
wherein the pressure regulating unit comprises a valve body being movable from a sealing position to a regulating position range and a motor unit for regulating the pressure of the respiratory gas supplied to the supply line by moving the valve body within the regulating position range, wherein,
when the valve body is in the sealing position, the pressurized source is sealed, and,
when the valve body is in the regulating position range, the pressurized source is adapted for supplying the respiratory gas to the supply line.
